(19) United States
(12) Patent Application Publication
(10) Pub. No.: US 2024/0073718 A1
(43) Pub. Date: Feb. 29, 2024

(54) CROSS-LINK INTERFERENCE MEASUREMENT ACTIVITY DURING NETWORK ENTITY INACTIVITY PERIOD

(71) Applicant: QUALCOMM Incorporated, San Diego, CA (US)

(72) Inventors: Konstantinos DIMOU, New York, NY (US); Jae Ho RYU, San Diego, CA (US); Ahmed ELSHAFIE, San Diego, CA (US)

(21) Appl. No.: 18/189,648

(22) Filed: Mar. 24, 2023

Related U.S. Application Data
(60) Provisional application No. 63/373,274, filed on Aug. 23, 2022.

(51) Int. Cl. H04W 24/08; H04W 52/02

(52) U.S. Cl. CPC H04W 24/08; H04W 52/0225

(57) ABSTRACT

Various aspects of the present disclosure generally relate to wireless communication. In some aspects, a user equipment (UE) may receive a message associated with cross-link interference (CLI) measurements during an inactivity period of a network entity. The UE may pause or continue CLI measurement activity during the inactivity period based at least in part on the message. Numerous other aspects are described.

### CROSS-REFERENCE TO RELATED APPLICATION

This Patent Application claims priority to U.S. Provisional Patent Application No. 63/373,274, filed on Aug. 23, 2022, entitled “CROSS-LINK INTERFERENCE MEASUREMENT ACTIVITY DURING NETWORK ENTITY INACTIVITY PERIOD,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for cross-link interference measurement activity during a network entity inactivity period.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a message associated with cross-link interference (CLI) measurements during an inactivity period of a network entity. The method may include pausing or continuing CLI measurement activity during the inactivity period based at least in part on the message.

Some aspects described herein relate to a method of wireless communication performed by a network entity. The method may include transmitting a message associated with CLI measurements during an inactivity period of a network entity. The method may include entering the inactivity period.

Some aspects described herein relate to a UE for wireless communication. The UE may include a memory and one or more processors coupled to the memory. The one or more processors may be configured to receive a message associated with CLI measurements during an inactivity period of a network entity. The one or more processors may be configured to pause or continue CLI measurement activity during the inactivity period based at least in part on the message.

Some aspects described herein relate to a network entity for wireless communication. The network entity may include a memory and one or more processors coupled to the memory. The one or more processors may be configured to transmit a message associated with CLI measurements during an inactivity period of a network entity. The one or more processors may be configured to enter the inactivity period.

Some aspects described herein relate to a non-transitory computer-readable medium that stores a set of instructions for wireless communication by a UE. The set of instructions, when executed by one or more processors of the UE, may cause the UE to receive a message associated with CLI measurements during an inactivity period of a network entity. The set of instructions, when executed by one or more processors of the UE, may cause the UE to pause or continue CLI measurement activity during the inactivity period based at least in part on the message.

Some aspects described herein relate to a non-transitory computer-readable medium that stores a set of instructions for wireless communication by a network entity. The set of instructions, when executed by one or more processors of the network entity, may cause the network entity to transmit a message associated with CLI measurements during an inactivity period of a network entity. The set of instructions, when executed by one or more processors of the network entity, may cause the network entity to enter the inactivity period.

Some aspects described herein relate to an apparatus for wireless communication. The apparatus may include means for receiving a message associated with CLI measurements during an inactivity period of a network entity. The apparatus may include means for pausing or continuing CLI measurement activity during the inactivity period based at least in part on the message.

Some aspects described herein relate to an apparatus for wireless communication. The apparatus may include means for transmitting a message associated with CLI measurements during an inactivity period of a network entity. The apparatus may include means for entering the inactivity period.

Aspects generally include a method, apparatus, system, computer program product, non-transitory computer-readable medium, UE, base station, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network entity (e.g., base station) in communication with a user equipment (UE) in a wireless network, in accordance with the present disclosure.

FIG. 3 is a diagram illustrating an example of a disaggregated base station, in accordance with the present disclosure.

FIG. 4 is a diagram illustrating an example of downlink semi-persistent scheduling communication and an example of uplink configured grant communication, in accordance with the present disclosure.

FIG. 5 is a diagram illustrating an example of using a transmit inactivity period, in accordance with the present disclosure.

FIG. 6 is a diagram illustrating examples of transmit inactive periods, in accordance with the present disclosure.

FIG. 7 is a diagram illustrating examples of downlink control information formats, in accordance with the present disclosure.

FIGS. 8A-8C are diagrams illustrating examples of full-duplex (FD) communication, in accordance with the present disclosure.

FIG. 9 is a diagram illustrating an example of full-duplex communication modes, in accordance with the present disclosure.

FIG. 10 is a diagram illustrating examples of full-duplex communication, in accordance with the present disclosure.

FIG. 11 is a diagram illustrating an example of measuring CLI in a transmit inactivity state, in accordance with the present disclosure.

FIG. 12 is a diagram illustrating an example of an indication for CLI activity during a network inactivity period, in accordance with the present disclosure.

FIG. 13 is a diagram illustrating an example process performed, for example, by a UE, in accordance with the present disclosure.

FIG. 14 is a diagram illustrating an example process performed, for example, by a network entity, in accordance with the present disclosure.

FIG. 15 is a diagram of an example apparatus for wireless communication, in accordance with the present disclosure.

FIG. 16 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

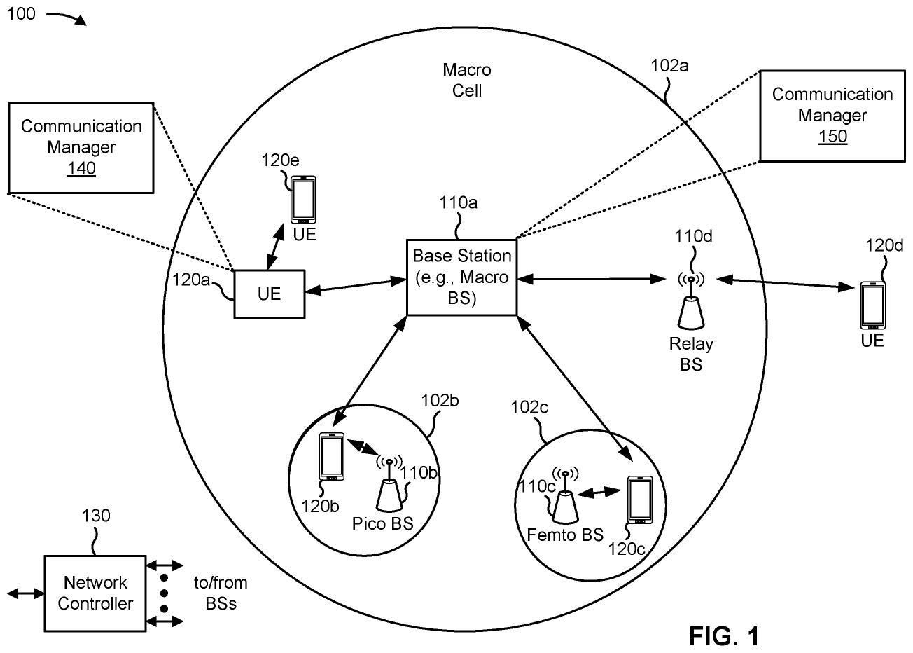

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include a user equipment (UE) 120 or multiple UEs 120 (shown as a UE 120a, a UE 120b, a UE 120c, a UE 120d, and a UE 120e). The wireless network 100 may also include one or more network entities, such as base stations 110 (shown as a BS 110a, a BS 110b, a BS 110c, and a BS 110d), and/or other network entities. A base station 110 is a network entity that communicates with UEs 120. A base station 110 (sometimes referred to as a BS) may include, for example, an NR base station, an LTE base station, a Entity B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network entities in the wireless network 100 through various types of backhaul interfaces, such as a direct physical connection or a virtual network, using any suitable transport network.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

The wireless network 100 may include one or more relay stations. A relay station is a network entity that can receive a transmission of data from an upstream station (e.g., a network entity or a UE 120) and send a transmission of the data to a downstream station (e.g., a UE 120 or a network entity). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network with network entities that include different types of BSs, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of network entities and may provide coordination and control for these network entities. The network controller 130 may communicate with the base stations 110 via a backhaul communication link. The network entities may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network entity, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network entity as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may receive a message associated with cross-link interference (CLI) measurements during an inactivity period of a network entity. The communication manager 140 may pause or continue CLI measurement activity during the inactivity period based at least in part on the message. Additionally, or alternatively, the communication manager 140 may perform one or more other operations described herein.

In some aspects, a network entity (e.g., base station 110) may include a communication manager 150. As described in more detail elsewhere herein, the communication manager 150 may transmit a message associated with CLI measurements during an inactivity period of a network entity. The communication manager 150 may enter the inactivity period. Additionally, or alternatively, the communication manager 150 may perform one or more other operations described herein.

As indicated above, FIG. 1 is provided as an example. Other examples may differ from what is described with regard to FIG. 1.

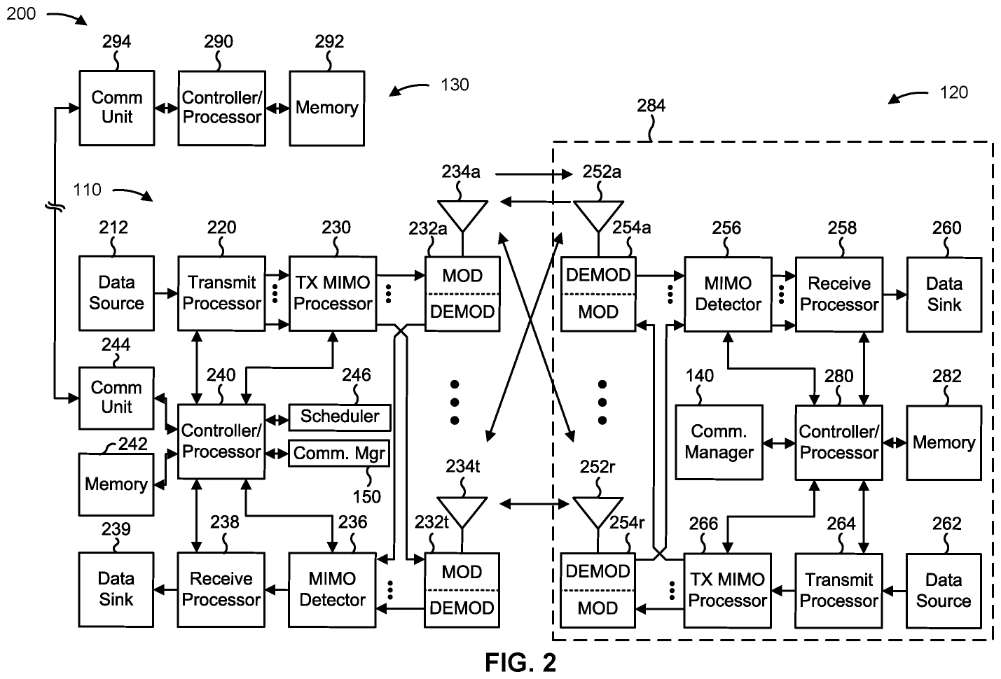

FIG. 2 is a diagram illustrating an example 200 of a network entity (e.g., base station 110) in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network entity via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

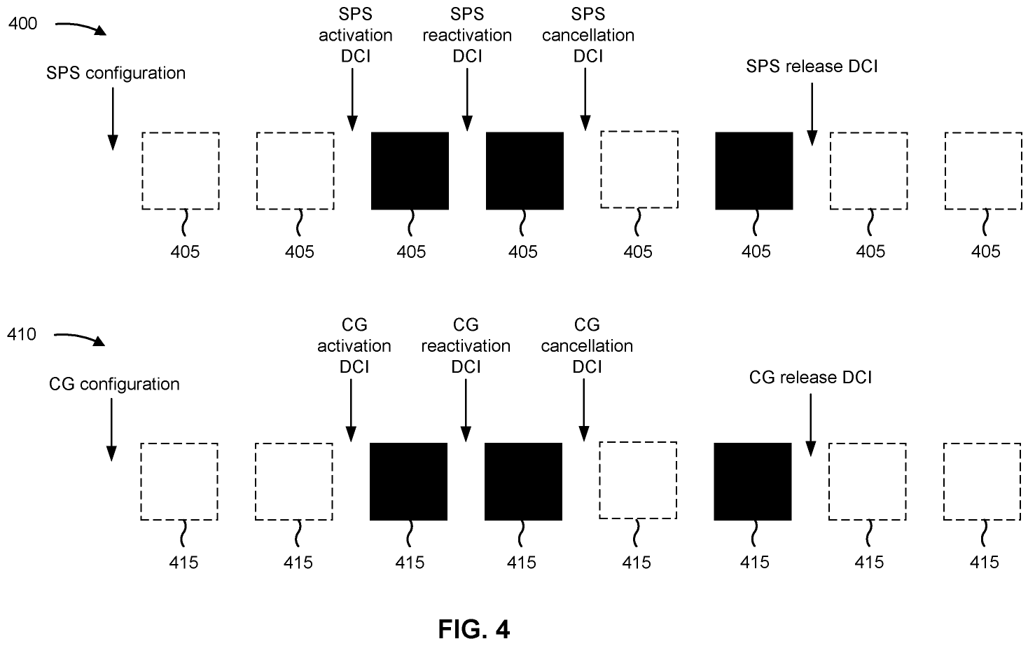

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network entity. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-16).

At the network entity (e.g., base station 110), the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network entity may include a communication unit 244 and may communicate with the network controller 130 via the communication unit 244. The network entity may include a scheduler 246 to schedule one or more UEs 120 for downlink and/or uplink communications. In some examples, the modem 232 of the network entity may include a modulator and a demodulator. In some examples, the network entity includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-16).

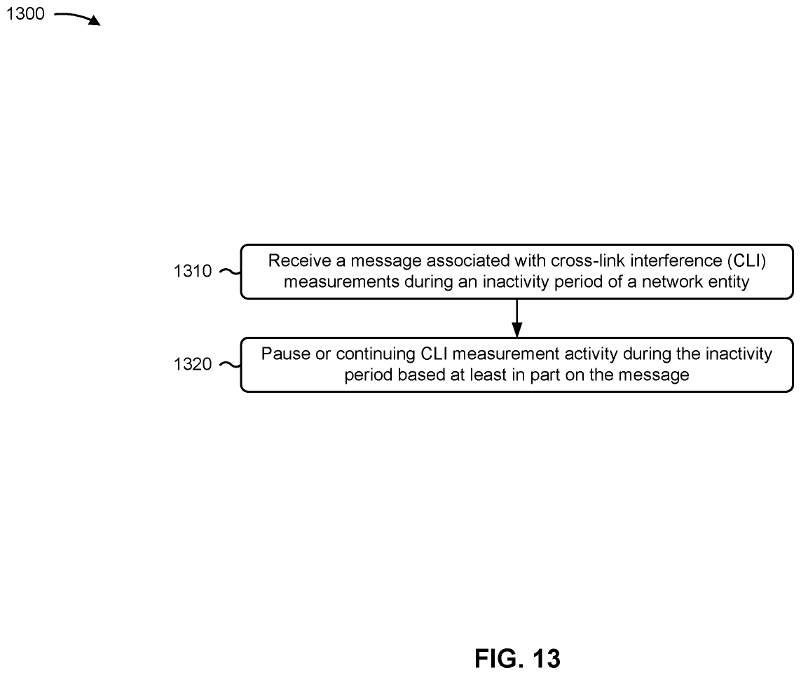

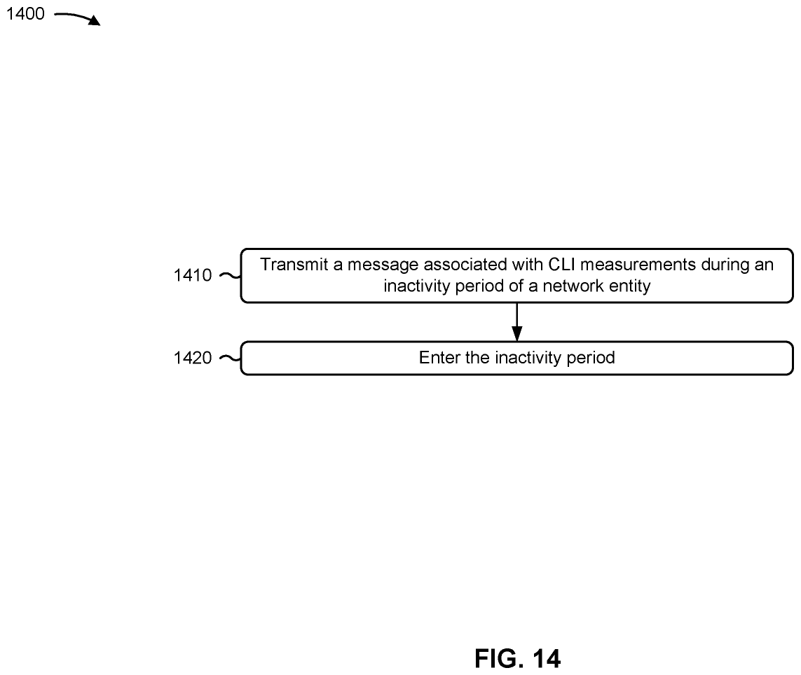

A controller/processor of a network entity (e.g., the controller/processor 240 of the base station 110), the controller/processor 280 of the UE 120, and/or any other component(s) of FIG. 2 may perform one or more techniques associated with CLI measurements during a network entity inactivity time, as described in more detail elsewhere herein. For example, the controller/processor 240 of the base station 110, the controller/processor 280 of the UE 120, and/or any other component(s) of FIG. 2 may perform or direct operations of, for example, process 1300 of FIG. 13, process 1400 of FIG. 14, and/or other processes as described herein. The memory 242 and the memory 282 may store data and program codes for the network entity and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network entity and/or the UE 120, may cause the one or more processors, the UE 120, and/or the network entity to perform or direct operations of, for example, process 1300 of FIG. 13, process 1400 of FIG. 14, and/or other processes as described herein. In some examples, executing instructions may include running the instructions, converting the instructions, compiling the instructions, and/or interpreting the instructions, among other examples.

In some aspects, the UE 120 includes means for receiving a message associated with CLI measurements during an inactivity period of a network entity; and/or means for pausing or continuing CLI measurement activity during the inactivity period based at least in part on the message. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., base station 110) includes means for transmitting a message associated with CLI measurements during an inactivity period of a network entity; and/or means for entering the inactivity period. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

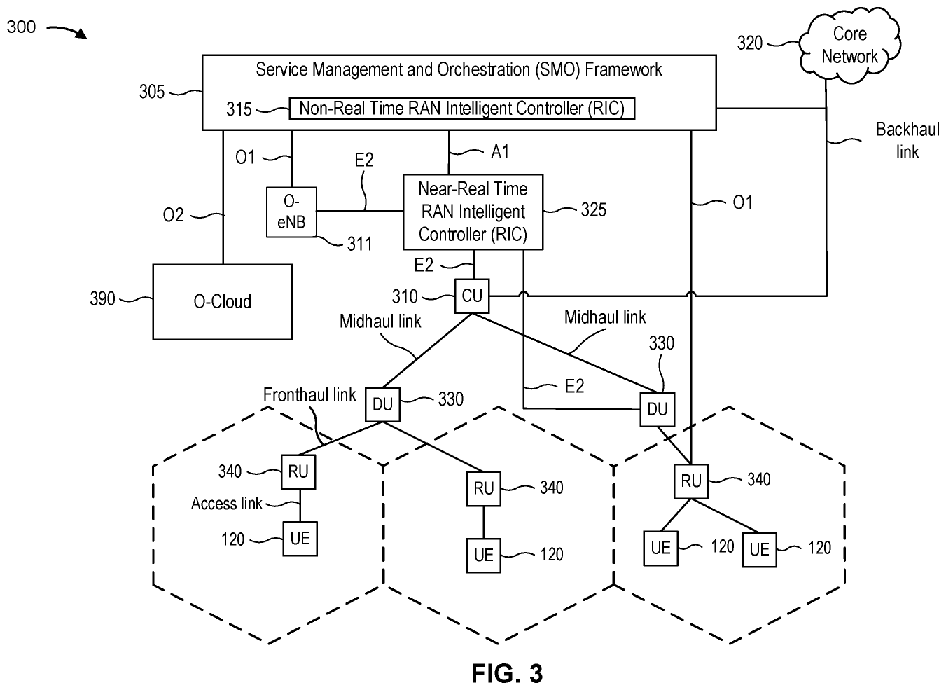

FIG. 3 is a diagram illustrating an example of a disaggregated base station 300, in accordance with the present disclosure.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station, or one or more units (or one or more components) performing base station functionality, may be implemented in an aggregated or disaggregated architecture. For example, a BS (such as a Node B, evolved NB (eNB), NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station 300 architecture may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The fronthaul link, the midhaul link, and the backhaul link may be generally referred to as “communication links.” The RUs 340 may communicate with respective UEs 120 via one or more RF access links. In some aspects, the UE 120 may be simultaneously served by multiple RUs 340. The DUs 330 and the RUs 340 may also be referred to as “O-RAN DUs (O-DUs”) and “O-RAN RUs (O-RUs)”, respectively. A network entity may include a CU, a DU, an RU, or any combination of CUs, DUs, and RUs. A network entity may include a disaggregated base station or one or more components of the disaggregated base station, such as a CU, a DU, an RU, or any combination of CUs, DUs, and RUs. A network entity may also include one or more of a TRP, a relay station, a passive device, an intelligent reflective surface (IRS), or other components that may provide a network interface for or serve a UE, mobile station, sensor/actuator, or other wireless device.

Each of the units (e.g., the CUs 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

FIG. 4 is a diagram illustrating an example 400 of downlink semi-persistent scheduling (SPS) communication and an example 410 of uplink configured grant (CG) communication, in accordance with the present disclosure. SPS communications may include periodic downlink communications that are configured for a UE, such that a network entity does not need to transmit (e.g., directly or via one or more network entities) separate downlink control information (DCI) to schedule each downlink communication, thereby conserving signaling overhead. CG communications may include periodic uplink communications that are configured for a UE, such that the network entity does not need to transmit (e.g., directly or via one or more network entities) separate DCI to schedule each uplink communication, thereby conserving signaling overhead.

As shown in example 400, a UE may be configured with an SPS configuration for SPS communications. For example, the UE may receive the SPS configuration via an RRC message transmitted by a network entity (e.g., directly to the UE or via one or more network entities). The SPS configuration may indicate a resource allocation associated with SPS downlink communications (e.g., in a time domain, frequency domain, spatial domain, and/or code domain) and a periodicity at which the resource allocation is repeated, resulting in periodically reoccurring scheduled SPS occasions 405 for the UE. The SPS configuration may also configure hybrid automatic repeat request (HARQ)-acknowledgement (ACK) (HARQ-ACK) feedback resources for the UE to transmit HARQ-ACK feedback for SPS physical downlink shared channel (PDSCH) communications received in the SPS occasions 405.

The network entity may transmit SPS activation DCI to the UE (e.g., directly or via one or more network entities) to activate the SPS configuration for the UE. The network entity may indicate, in the SPS activation DCI, communication parameters, such as an MCS, a resource block (RB) allocation, and/or antenna ports, for the SPS PDSCH communications to be transmitted in the scheduled SPS occasions 405. The UE may begin monitoring the SPS occasions 405 based at least in part on receiving the SPS activation DCI. The UE may refrain from monitoring configured SPS occasions 405 prior to receiving the SPS activation DCI. The network entity may transmit SPS reactivation DCI to the UE (e.g., directly or via one or more network entities) to change the communication parameters for the SPS PDSCH communications.

In some cases, such as when there is no downlink traffic to transmit to the UE, the network entity may transmit SPS cancellation DCI to the UE (e.g., directly or via one or more network entities) to temporarily cancel or deactivate one or more subsequent SPS occasions 405 for the UE. The SPS cancellation DCI may deactivate only a subsequent one SPS occasion 405 or a subsequent N SPS occasions 405 (where N is an integer). SPS occasions 405 after the one or more (e.g., N) SPS occasions 405 subsequent to the SPS cancellation DCI may remain activated. Based at least in part on receiving the SPS cancellation DCI, the UE may refrain from monitoring the one or more (e.g., N) SPS occasions 405 subsequent to receiving the SPS cancellation DCI. The network entity may transmit SPS release DCI to the UE (e.g., directly or via one or more network entities) to deactivate the SPS configuration for the UE. The UE may stop monitoring the scheduled SPS occasions 405 based at least in part on receiving the SPS release DCI.

As shown in example 410, a UE may be configured with a CG configuration for CG communications. For example, the UE may receive the CG configuration via an RRC message transmitted by a network entity (e.g., directly to the UE or via one or more network entities). The CG configuration may indicate a resource allocation associated with CG uplink communications (e.g., in a time domain, frequency domain, spatial domain, and/or code domain) and a periodicity at which the resource allocation is repeated, resulting in periodically reoccurring scheduled CG occasions 415 for the UE. In some examples, the CG configuration may identify a resource pool or multiple resource pools that are available to the UE for an uplink transmission. The CG configuration may configure contention-free CG communications (e.g., where resources are dedicated for the UE to transmit uplink communications) or contention-based CG communications (e.g., where the UE contends for access to a channel in the configured resource allocation, such as by using a channel access procedure or a channel sensing procedure).

The network entity may transmit CG activation DCI to the UE (e.g., directly or via one or more network entities) to activate the CG configuration for the UE. The network entity may indicate, in the CG activation DCI, communication parameters, such as an MCS, an RB allocation, and/or antenna ports, for the CG physical uplink shared channel (PUSCH) communications to be transmitted in the scheduled CG occasions 415. The UE may begin transmitting in the CG occasions 415 based at least in part on receiving the CG activation DCI.

The network entity may transmit CG reactivation DCI to the UE (e.g., directly or via one or more network entities) to change the communication parameters for the CG PUSCH communications. Based at least in part on receiving the CG reactivation DCI, the UE may begin transmitting in the scheduled CG occasions 415 using the communication parameters indicated in the CG reactivation DCI. In some cases, such as when the network entity is expected to override a scheduled CG communication for a higher priority communication, the network entity may transmit CG cancellation DCI to the UE (e.g., directly or via one or more network entities) to temporarily cancel or deactivate one or more subsequent CG occasions 415 for the UE. The network entity may transmit CG release DCI to the UE (e.g., directly or via one or more network entities) to deactivate the CG configuration for the UE. The UE may stop transmitting in the scheduled CG occasions 415 based at least in part on receiving the CG release DCI.

As indicated above, FIG. 4 is provided as an example. Other examples may differ from what is described with respect to FIG. 4.

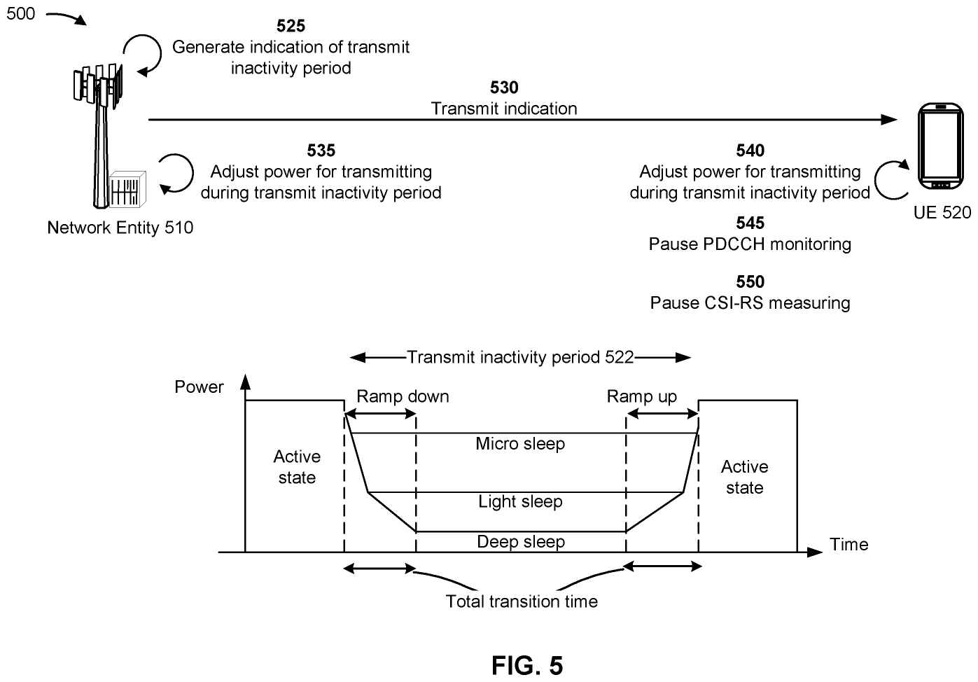

FIG. 5 is a diagram illustrating an example 500 of using a transmit inactivity period, in accordance with the present disclosure. Example 500 shows a network entity 510 (e.g., base station 110) and a UE 520 (e.g., UE 120) that may communicate with each other via a wireless network (e.g., wireless network 100).

Energy costs make up a large percentage of the operating costs for a network. Accordingly, networks are being designed to be more energy efficient and environmentally responsible. These designs may include the use of a sleep state by the network entity 510, where the network entity 510 powers down radio components or other components (partially or fully) at times to reduce energy consumption.

In some aspects, the network entity 510 may indicate a transmit inactivity period that allows the network entity 510 and/or the UE 520 more opportunities than current network configurations to enter a sleep state and thus consume less energy. The network entity 510 may indicate this transmit inactivity period to UEs. As a result, the network entity 510 and UEs 520 served by the network entity 510 may have more opportunities to sleep and to reduce power consumption.

In some implementations, the transmit inactivity period may be indicated as a pattern (e.g., a pattern of inactive BS TX Inactive states relative to active states), and the pattern may be a dynamic pattern or a periodic pattern. The network entity 510 may indicate the dynamic pattern via an RRC message and/or Layer 1 (L1) signaling (e.g., DCI, a MAC control element (MAC CE)). For example, the network entity 510 may use RRC signaling to configure the UE 520 with the option of transmitting group common DCI in the cell to indicate the “BS TX Inactive” state. The group common DCI may trigger the start and duration of the “BS TX Inactive” state. UEs may then pause monitoring for physical downlink control channel (PDCCH) communications and pause measuring periodic or semi-persistent channel state information (CSI) reference signals (CSI-RS s) (if configured) during the “BS TX Inactive” state (or mode). The time duration during which the network entity 510 is in the BS TX Inactive state may be referred to as a network “transmit inactivity period.” The transmit inactivity period may be a period between active states or a period when the network entity 510 is powered down below a threshold power level. Example 500 shows an example transmit inactivity period 522.

In some aspects, the network entity 510 may define, trigger, and/or configure one or more transmit inactivity periods for the BS TX Inactive state without affecting downlink traffic performance. However, before initiating (and indicating) a transmit inactivity period, the network entity 510 may check whether one or more conditions are satisfied. If the conditions are satisfied, the network entity 510 may generate an indication of a transmit inactivity period, as shown by reference number 525. For example, the network entity 510 may generate the indication if a condition is satisfied where there is no downlink traffic with a latency requirement that is less than the period (time duration) of the transmit inactivity period (in the cell or in neighbor cells) and there is no periodic downlink traffic (e.g., SPS traffic) with a period that is shorter than the period of the transmit inactivity period. In other words, the network entity 510 may check that there is no low-latency downlink traffic to be transmitted. If there is such downlink traffic, the network entity may not initiate or indicate a transmit inactivity period.

While the network entity 510 may check for downlink traffic, the network entity may also check for uplink traffic because of the downlink traffic that is associated with scheduling the uplink traffic. For example, the network entity 510 may generate the indication (and initiate the BS TX Inactive state) if a condition is satisfied where there is no uplink traffic with a latency requirement that is less than the period of the transmit inactivity period, no uplink traffic is dynamically scheduled (via DCI), and retransmissions are allowed (via DCI) (in the current cell or in neighbor cells). The network entity 510 may generate the indication if a condition is satisfied where there is no periodic uplink traffic (e.g., CG) with a period that is shorter than the period of the transmit inactivity period and retransmissions are configured. If there is such uplink traffic, the network entity may not initiate or indicate a transmit inactivity period. Note that the network entity 510 may ensure that a synchronization signal block (SSB) is not skipped if certain types of UEs are present (e.g., UEs that use features specified by 3GPP Release 17) and that radio access channel (RACH) occasions (ROs) are not skipped. The network entity 510 may be aware of the above conditions by using Release 17 signaling procedures (e.g., RRC signaling, DCI, a MAC CE).

If the above conditions for downlink traffic and uplink traffic are satisfied, the network entity 510 may generate the indication of a transmit inactivity period. During the transmit inactivity period, the network entity 510 may also adjust the transmit power of the network entity 510. This may include, for example, reducing power of the network entity 510 for transmitting during the transmit inactivity period. The reduction of the power for transmitting may be part of entering an inactive state or a sleep state. By contrast, an active state or awake state may include a state of processing (e.g., decoding and/or demodulating) downlink signals, uplink signals, and/or channels. The amount of power that the network entity 510 consumes during an awake state may scale (increase or decrease) based at least in part on a quantity of component carriers (CCs), resource utilization, a quantity of antenna ports, a quantity of spatial layers, and/or a quantity of antenna elements.

Example 500 also shows how the network entity 510 may ramp power down from an active state to a sleep state and ramp power back up to an active state. As the time between active states increases, more components can be turned off (power withdrawn) to conserve more power, including a radio (radio components) that is used for transmission and/or reception. For example, the network entity 510 may switch off the radio frequency (RF) part and/or a broadband part of a transmit chain, such that the network entity 510 will not transmit any communications. Switching between a transmit (downlink) active state (transmitting) and a transmit inactive state (not transmitting) may be an operation of a discontinuous transmission (DTX) mode, also referred to as “BS in DTX mode.” The transmit active state of the network entity 510 may be referred to as a “BS transmit active” state, and the inactive transmit state of the network entity 510 may be referred to as a “BS TX inactive” state. During the inactive transmit state, there are no downlink transmissions and the network entity 510 can enter a sleep state. During the active transmit state, downlink transmissions are possible, and the network entity 510 cannot enter the sleep state.

The network entity 510 may reduce power by varying amounts. For example, a sleep state may include varying levels of sleep, such as a micro sleep, a light sleep, or a deep sleep. A micro sleep may cause the network entity 510 to use a reduced amount of power for the radio as compared to the active state. This reduction in power may be much less than the reduction in power for a deep sleep (e.g., a deep sleep may have a reduction in power that is 15 times that of a micro sleep). However, a micro sleep may have very little transition time (e.g., less than 1 millisecond (ms)) and may use little transition energy. A light sleep may be a sleep level between a micro sleep and a deep sleep, with a power reduction that is, for example, half that of a deep sleep. A light sleep may have a slower transition time (e.g., 6 ms) than a micro sleep, but may still be quicker than a deep sleep. A light sleep may cause the network entity 510 to use additional transition energy (relative power vs. ms) that can be about 20 times that of a micro sleep. A deep sleep may have the longest sleep period and/or the greatest energy reduction. The deep sleep may also have the longest transition time (e.g., 20 ms) and cause the network entity 510 to use the greatest amount of energy for transition (e.g., about 100 times that of the micro sleep).

As shown by reference number 530, the network entity 510 may transmit the indication. The indication may specify a periodic BS DTX pattern, with “BS Tx Active” and “BS Tx Inactive” durations, or a dynamic BS DTX pattern, in which “BS Tx Inactive” periods are triggered dynamically by the network entity 510.

As shown by reference number 535, the network entity 510 may adjust a power (e.g., decrease power, set a new power) for transmitting based at least in part on the indication. This may include adjusting the power to be at a reduced level during the transmit inactivity period. For example, as shown by reference number 540, the UE 520 may adjust a power for receiving during the transmit inactivity period. The UE 520 may use the indication of the transmit inactivity period to reduce power to a receiving radio (e.g., enter a sleep state), or perform other operations that do not involve the network entity 510, during the transmit inactivity period of the network entity 510. During the transmit inactivity period, the UE 520 may pause (refrain from) actions such as PDCCH monitoring (shown by reference number 545) and/or CSI-RS measuring (shown by reference number 550). This is because during the transmit inactivity period, the network entity 510 may not transmit PDCCH communications, periodic CSI-RSs, and semi-persistent CSI-RSs. In this way, the network entity 510 may reduce power consumption. The UE 520 may also reduce power consumption and conserve battery power.

If the UE 520 exits the transmit inactivity period, the UE 520 may remain in an active state (e.g., awake) for the duration of an inactivity timer (e.g., which may extend the active time). The UE 120 may start the inactivity timer at a time at which the PDCCH communication is received (e.g., in a transmission time interval in which the PDCCH communication is received, such as a slot or a subframe). The UE 520 may remain in the active state until the inactivity timer expires, at which time the UE 520 may enter the sleep state (e.g., for the inactive transmit time). During the duration of the inactivity timer, the UE 520 may continue to monitor for PDCCH communications, may obtain a downlink data communication (e.g., on a downlink data channel, such as a PDSCH) scheduled by the PDCCH communication, and/or may prepare and/or transmit an uplink communication (e.g., on a PUSCH) scheduled by the PDCCH communication. The UE 520 may restart the inactivity timer after each detection of a PDCCH communication for the UE 520 for an initial transmission (e.g., but not for a retransmission).

In some aspects, the network entity 510 may utilize an inactive receive time or a “BS in DRX mode,” where DRX is discontinuous reception. The receive inactive state of the network entity 510 may be referred to as a “BS Rx Inactive” state or a receive inactivity period. In the receive inactivity period, the network entity 510 may cause radio receiver components or other components to enter a sleep state (e.g., micro sleep, light sleep, deep sleep).

As indicated above, FIG. 5 is provided as an example. Other examples may differ from what is described with respect to FIG. 5.

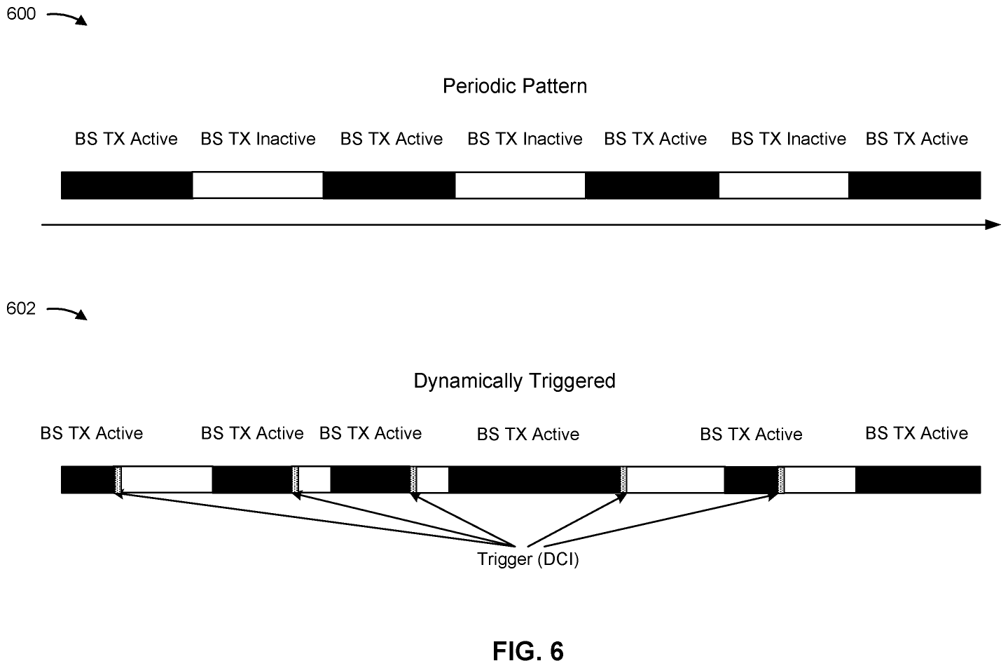

FIG. 6 is a diagram illustrating examples 600 and 602 of transmit inactive periods, in accordance with the present disclosure.

Example 600 shows a periodic DTX pattern of inactive transmit states (BS TX Inactive), each inactive transmit state having a transmit inactivity period. The network entity 510 may transmit the indication of the transmit inactivity period using, for example, RRC signaling. This may include via system information (SI) or via dedicated RRC signaling.

Example 602 shows dynamically triggered transmit inactivity states, where a triggering DCI indicates a timing of one or more transmit inactivity states. This may include a combination of RRC signaling and L1 signaling. The RRC level configuration may configure the option of having transmit inactivity periods and a list of N transmit inactivity periods with associated parameters (e.g., starting slot offset, duration), as part of a DTX pattern. The RRC signaling may include information about the periodic DTX pattern or DTX configurations in an information element (IE) in a system information block (SIB). The DCI may trigger one of the N RRC configured transmit inactivity periods. In case of signaling via an SIB, paging to UEs is expected and an update of a DTX pattern is possible only after a paging cycle. The minimum value of a paging cycle may be 32 radio frames.

For both the periodic DTX pattern and the dynamic DTX pattern, the start of a transmit inactivity period implies that UEs do not monitor for PDCCH communications and do not perform CSI-RS measurements (of all types). In some aspects, the set or list of configured transmit inactivity periods may be reconfigured. In some aspects, the network entity 510 may switch from a periodic DTX pattern to a dynamic DTX pattern.

As indicated above, FIG. 6 provides some examples. Other examples may differ from what is described with regard to FIG. 6.

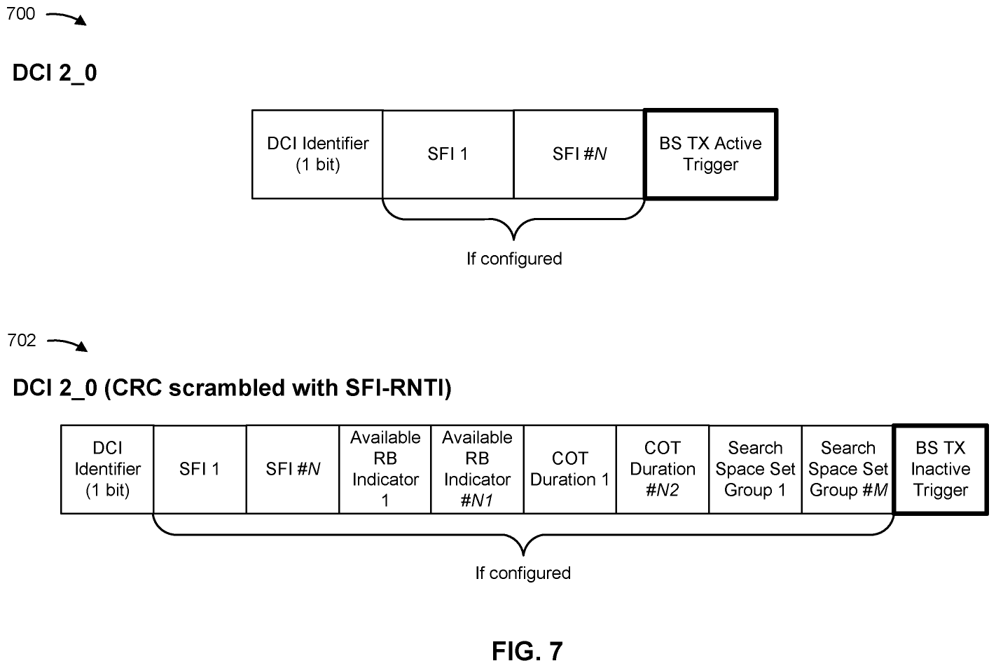

FIG. 7 is a diagram illustrating examples 700 and 702 of DCI formats, in accordance with the present disclosure.

Example 700 shows a DCI format 2_0 for signaling a transmit inactivity period. The DCI format may include a DCI identifier (ID) and slot format indicators (SFIs), if configured. The DCI may further include a BS TX Inactive trigger. The BS TX Inactive trigger may indicate one of multiple preconfigured DTX patterns that may include a starting slot offset (e.g., a starting slot or sub-slot from a current slot) and/or a duration (e.g., quantity of slots or sub-slots).

Example 702 shows a DCI format 2_0 that may be scrambled with an SFI radio network temporary identifier (RNTI). This may include up to 128 bits. The DCI may include information for SFIs, RBs, channel occupancy time (COT), and search space set groups, if configured. The DCI may further include a BS TX Inactive trigger. The BS TX Inactive trigger may indicate a starting slot offset and/or a duration. By triggering transmit inactivity states, the network entity 510 may increase the opportunities to enter the sleep state and reduce power consumption.

As indicated above, FIG. 7 is provided as an example. Other examples may differ from what is described with regard to FIG. 7.

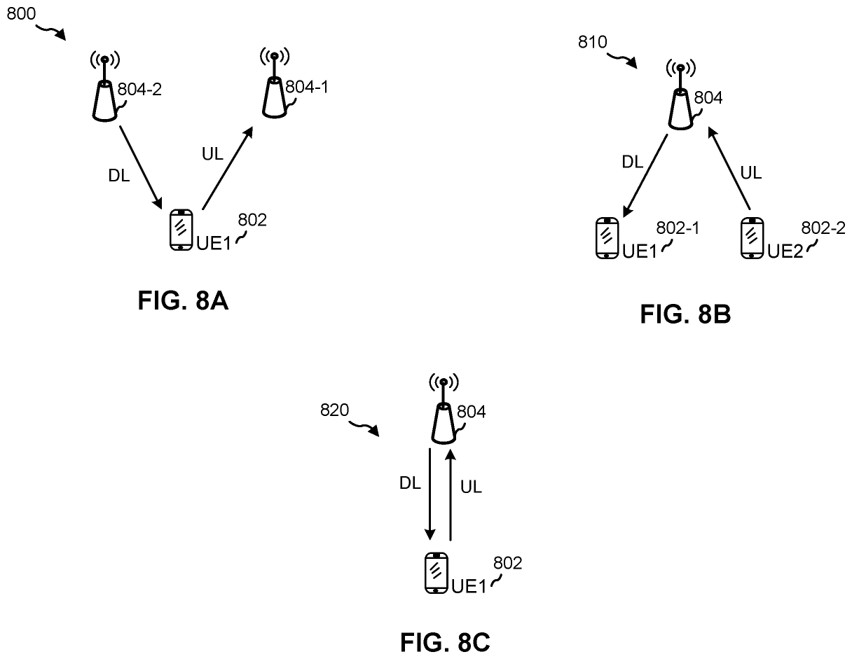

FIGS. 8A-8C are diagrams illustrating examples of full-duplex (FD) communication in accordance with the present disclosure. A first full-duplex scenario 800 depicted in FIG. 8A includes a UE1 802 and two base stations (e.g., network entities or TRPs) 804-1, 804-2, where the UE1 802 is sending uplink transmissions to base station 804-1 and is receiving downlink transmissions from base station 804-2. In the first full-duplex scenario 800 of FIG. 8A, FD is enabled for the UE1 802, but not for the base stations 804-1, 804-2. A second full-duplex scenario 810 depicted in FIG. 8B includes two UEs, shown as UE1 802-1 and UE2 802-2, and a base station 804, where the UE1 802-1 is receiving a downlink transmission from the base station 804 and the UE2 802-2 is transmitting an uplink transmission to the base station 804. In the second full-duplex scenario 810, FD is enabled for the base station 804, but not for UE1 802-1 and UE2 802-2. A third full-duplex scenario 820 is depicted in FIG. 8C that includes a UE1 802 and a base station 804, where the UE1 802 is receiving a downlink transmission from the base station 804 and the UE1 802 is transmitting an uplink transmission to the base station 804. In the third full-duplex scenario 820, FD is enabled for both the UE1 802 and the base station 804.

As indicated above, FIGS. 8A-8C provide some examples. Other examples may differ from what is described with regard to FIGS. 8A-8C.

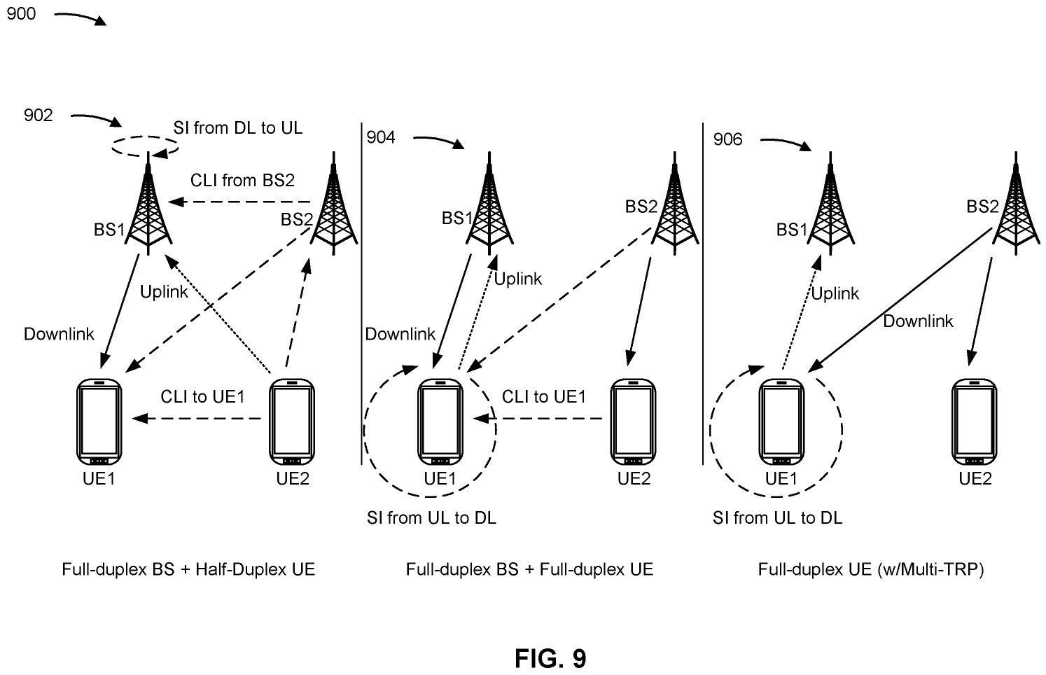

FIG. 9 is a diagram illustrating an example of full-duplex communication modes 900, in accordance with the present disclosure. In a first mode 902, a first network entity (shown as BS1) and a second network entity (shown as BS2) may be full-duplex devices (e.g., may be capable of communicating in a full-duplex manner). A first UE and a second UE may be half duplex UEs (e.g., may not be capable of communicating in a full-duplex manner). The first network entity may perform downlink transmissions to the first UE, and the first network entity may receive uplink transmissions from the second UE. The first network entity may experience SI from a downlink to an uplink based at least in part on the downlink transmissions to the first UE and the uplink transmissions received from the second UE. The first network entity may experience CLI from the second network entity. The first UE may experience CLI from the second network entity and the second UE.

In a second mode 904, a first network entity and a second network entity may be full-duplex devices. A first UE and a second UE may be full-duplex UEs. The first network entity may perform downlink transmissions to the first UE, and the first network entity may receive uplink transmissions from the first UE. The first UE may experience SI from an uplink to a downlink based at least in part on the downlink transmissions from the first network entity and the uplink transmissions to the first network entity. The first UE may experience CLI from the second network entity and the second UE.

In a third mode 906, a first UE and a second UE may be full-duplex UEs and may communicate in a multi-TRP configuration. A first network entity may receive uplink transmissions from the first UE, and a second network entity may perform downlink transmissions to the first UE and the second UE. The first UE may experience SI from an uplink to a downlink based at least in part on the uplink transmissions to the first network entity and the downlink transmissions from the second network entity.

As indicated above, FIG. 9 is provided as an example. Other examples may differ from what is described with regard to FIG. 9.

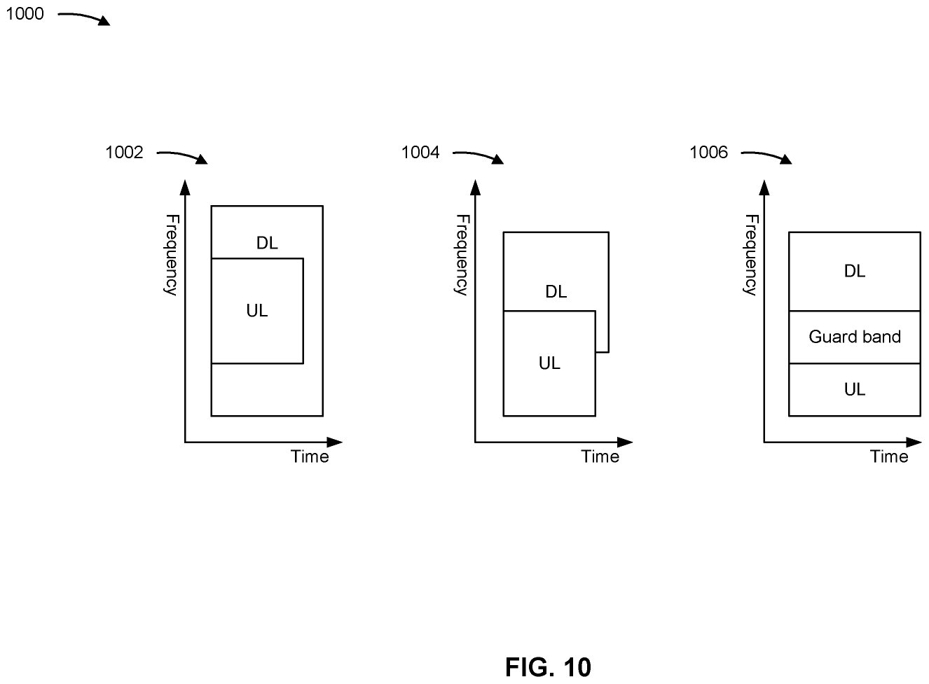

FIG. 10 is a diagram illustrating examples of full-duplex communication 1000, in accordance with the present disclosure. In some cases, a wireless communication device (such as a UE or a network entity) may support full-duplex operations. Full-duplex operations may include the wireless communication device transmitting and receiving at approximately the same time.

A UE may operate in an in-band full-duplex mode. In the in-band full-duplex mode, the UE may transmit and receive on a same time and frequency resource. An uplink and a downlink may share the same time and frequency resource. For example, in a first full-duplex communication 1002, a time and frequency resource for the uplink may fully overlap with a time and frequency resource for the downlink. As another example, in a second full-duplex communication 1004, a time and frequency resource for the uplink may partially overlap with a time and frequency resource for the downlink.

Full-duplex operations may include a subband full-duplex (SBFD) mode. The SBFD mode may also be referred to as a subband frequency division duplex mode or a flexible duplex mode. SBFD communication 1006 shows that the wireless communication device may transmit and receive at a same time (in the same SBFD slot), but the wireless communication device may transmit and receive on different frequency domain resources. For example, a network entity may be operating in an SBFD mode. The network entity may schedule a first UE to receive a downlink communication in an SBFD slot. The network entity may schedule a second UE to transmit an uplink communication in the same SBFD slot. However, the uplink communication may cause interference for the first UE that is receiving the downlink communication. To address this, a downlink time/frequency resource in the SBFD slot may be separated (e.g., in time or frequency) from an uplink time/frequency resource in the SBFD slot by a gap, which may function to reduce self-interference and improve latency and uplink coverage. The gap may be a frequency offset or a frequency gap (guard band) between downlink time/frequency resources and uplink time/frequency resources in the same SBFD slot. In some cases, a slot pattern may include a combination of downlink slots, uplink slots, or SBFD slots.

If a UE is operating in half-duplex mode and a network entity (e.g., gNB) is operating in SBFD or inter-band FD (IBFD), there may be multiple sources of interference at the UE. Such interference may include inter-cell interference from other network entities, intra-cell CLI from UEs in the same cell, and/or inter-cell CLI from UEs in adjacent cells. There may also be SI for full-duplex UEs.

Some uplink traffic models have periodic patterns, and victim UEs (UEs experiencing interference) may experience CLI or SI with periodic patterns. To obtain accurate semi-static interference measurements, a network entity may configure the victim UE to report CLI via an uplink MAC CE, which may be considered Layer 2 (L2) reporting. The network entity may configure an aggressor UE (UE causing interference for victim UE) with a semi-persistent (SP) or periodic sounding reference signal (SRS) resource set. An SP SRS may be activated or deactivated via a MAC CE and indicate a transmit power, such as a maximum power (e.g., P_{cmax}). The network entity may configure a victim UE with SP CSI interference measurement (CSI-IM) resources, which are activated or deactivated via MAC CE. CLI may be measured by the victim UE as a function of transmit power and coupling loss. If the coupling loss is known, the victim UE may estimate CLI for different transmit powers.

In some examples, L2 event-based CLI reporting may include periodic victim reports with one or more CLI values. A CLI value may include an indication of an amount of CLI interference, such as a decibel (dB) value or a dB milliwatt (dBm) value. The CLI value may be an indication of a CLI measurement, such as an RSRP, an RSSI, or a signal-to-noise-plus-interference ratio (SINR). The reporting may be based on triggering events, such as movement of the UE or activation or deactivation of communications by nearby UEs or network entities. The UE may transmit a MAC CE for triggering CSI-IM and CLI reporting. Other UEs or network entities may indicate CLI values as part of CLI reciprocity.

In some aspects, a UE may transmit a MAC CE that includes one or more reports of CLI or SI at the UE. A report may include a CLI value. For example, a CLI value may include a CLI level that is based at least in part on a CLI measurement (e.g., RSRP, RSSI, SINR) of a CLI resource (e.g., reference signal, communication). The CLI level may be indicated using one or more bits. The MAC CE may follow one of a various quantity of structures for conveying CLI levels. In some aspects, the UE may quantize a CLI measurement before reporting. For example, the CLI level may be a quantized value of a CLI measurement, an average of CLI measurements, a maximum of CLI measurements, a minimum of CLI measurements, or another value associated with CLI. A CLI measurement may be quantized into a different quantity of bits, such as 7 bits for a base measurement and 4 bits for a differential measurement (difference between current measurement and base measurement).

As indicated above, FIG. 10 is provided as an example. Other examples may differ from what is described with regard to FIG. 10.

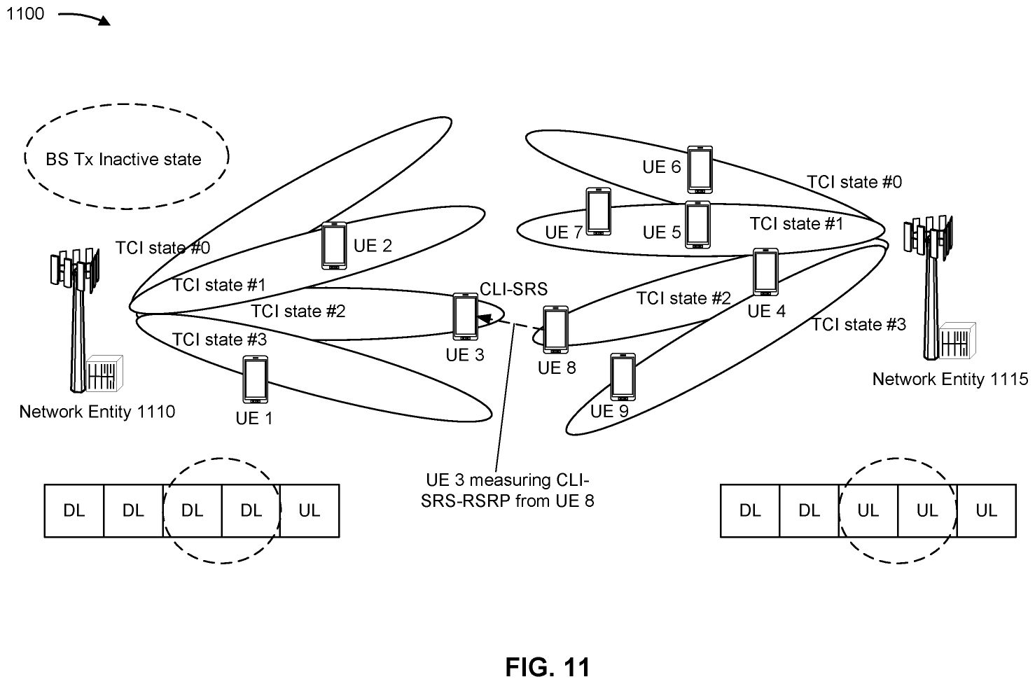

FIG. 11 is a diagram illustrating an example 1100 of measuring CLI in a transmit inactivity state, in accordance with the present disclosure. A first network entity 1110 (e.g., base station 110) and a second network entity 1115 (e.g., base station 110) may transmit multiple beams to multiple UEs. Each beam may be associated with a transmission configuration indicator (TCI) state. The network entity 1110 may determine to enter a transmit inactivity state during two downlink slots of a configured slot pattern. Although the network entity 1110 may not be transmitting, a UE (e.g., UE 3) may be receiving a CLI SRS from UE 8 during the transmit inactivity state of network entity 1110. UE 3 may be able to measure the CLI SRS to obtain a measurement (e.g., RSRP) during the transmit inactivity state of the network entity 1110. However, it is not clear what UE 3 is to do with the CLI measurement during the transmit inactivity period of the network entity 1110. The CLI measurements may be a waste of UE 3′s processing resources. Furthermore, if the network entity 1110 is in a receive inactivity period, the UE 3 would waste processing resources and signaling resources transmitting CLI measurements to the network entity 1110 during the receive inactivity period.

As indicated above, FIG. 11 is provided as an example. Other examples may differ from what is described with regard to FIG. 11.

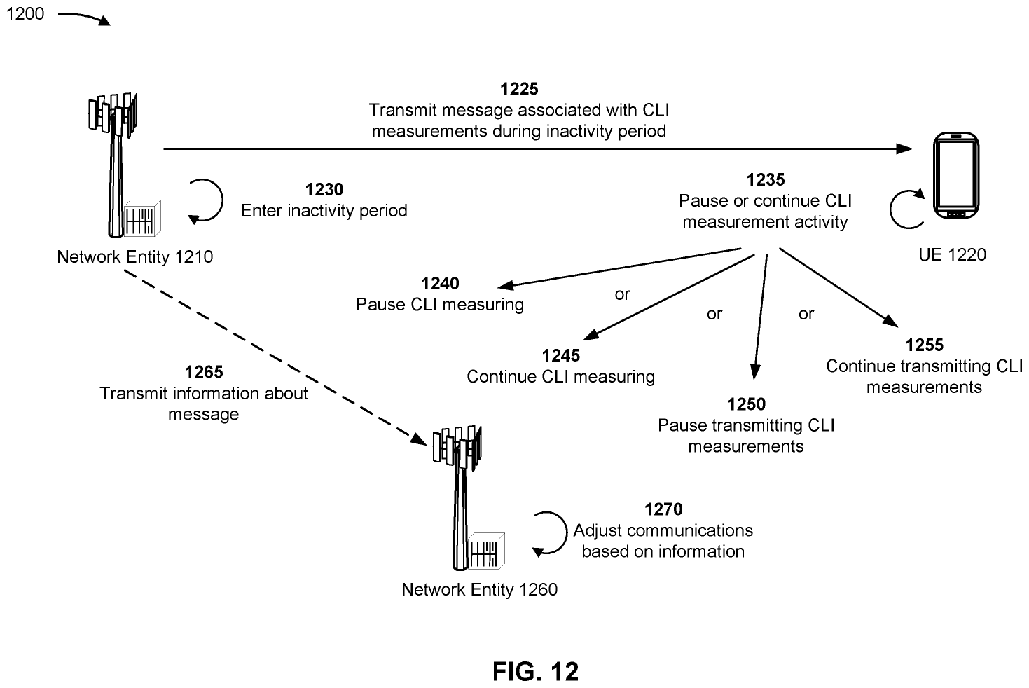

FIG. 12 is a diagram illustrating an example 1200 of an indication for CLI activity during a network inactivity period, in accordance with the present disclosure. Example 1200 shows a network entity 1210 (e.g., base station 110) and a UE 1220 (e.g., UE 120) that may communicate with each other via a wireless network (e.g., wireless network 100). The network entity 1210 may be a serving cell.

According to various aspects described herein, the network entity 1210 may transmit a message associated with CLI measurements during an inactivity period of the network entity 1210, as shown by reference number 1225. The message may be a pause message that indicates pausing the CLI measurement activity during the inactivity period. Pausing the CLI measurement activity may include interrupting and/or refraining from CLI measurement activity. The message may be a continue message that indicates continuing with CLI measurement activity during the inactivity period. Continuing the CLI measurement activity may include not pausing the CLI measurement activity. The message may be a “true” or “false” value for an indication of whether to continue CLI measurements in a BS TX Inactive trigger field of DCI. The inactivity period may be a network transmit inactivity period and/or a network receive inactivity period. As shown by reference number 1230, the network entity 1210 may then enter the inactivity period. For example, the network entity 1210 may enter or start the inactivity period after, based on, and/or in response to transmitting the message at reference number 1225. By transmitting a pause message or a continue message for CLI measurement activity during a network inactivity period, the network entity may control CLI measurement activity during the network inactivity period. In this way, the network entity may pause CLI measurement activity to conserve power, processing resources, and signaling resources when CLI measurements may be wasted or continue CLI measurement activity during the network inactivity period when CLI measurements can be used to mitigate CLI.

As shown by reference number 1235, the UE 1220 may pause or continue CLI measurement activity during the inactivity period based at least in part on the message. CLI measurement activity may include measuring CLI. CLI measurement activity may include transmitting CLI measurements that are based on the measuring of CLI. CLI measurement activity may include combination of measuring CLI and transmitting the CLI measurements.

In one example, the message may be a pause message for a transmit inactivity period, and the UE 1220 may pause measuring CLI, as shown by reference number 1240. The UE 1220 may pause measuring of CLI during the transmit inactivity period based at least in part on one or more CLI measurements not satisfying a signal strength threshold (e.g., minimum RSRP). The CLI measurements may be previous CLI measurements, or CLI measurements taken within a specified time duration prior to the present time. For example, a CLI measurement may satisfy the signal strength threshold if the signal strength of the CLI measurement is equal to or greater than the signal strength threshold. The UE 1220 may ignore a pause message if the CLI from neighboring entities is greater than the signal strength threshold. Ignoring the pause a message may include continuing and not pausing CLI measurements. The CLI measurement may not satisfy the signal strength threshold if the signal strength of the CLI measurement is less than the signal strength threshold. In some aspects, the UE 1220 may pause measuring of CLI based at least in part on the power level of the UE 1220 not satisfying a power level threshold (e.g., minimum battery percentage). For example, the UE 1220 may pause measuring during the transmit inactivity period if the UE 1220 is getting low on power. If the UE 1220 is not measuring CLI during the transmit inactivity period, the UE 1220 may enter a sleep state.

In an example, the message may be a continue message for a transmit inactivity period, and the UE 1220 may continue measuring CLI, as shown by reference number 1245. The UE 120 may continue measuring CLI if the CLI is greater than the signal strength threshold. The UE 1220 may continue measuring CLI if the power level of the UE 1220 satisfies the power level threshold (e.g., has enough battery power). The network entity 1210 may generate the message based at least in part on these conditions. In some aspects, the UE 1220 may receive, before continuing measuring of CLI, a request to pause measuring of CSI-RS s, such as non-zero power (NZP) CSI-RSs, during the transmit inactivity period and ignore the request if the power level of the UE 1220 satisfies the power level threshold.

In an example, the message may be a pause message for a receive inactivity period, and the UE 1220 may pause transmitting of CLI measurements, as shown by reference number 1250. The UE 1220 may pause transmitting of the CLI measurements if one or more CLI measurements (e.g., previous CLI measurements) do not satisfy the signal strength threshold. The UE 1220 may pause transmitting of the CLI measurements if the power level of the UE 1220 does not satisfy the power level threshold. The UE 1220 may transmit the CLI measurements after an end of the receive inactivity period.

In an example, the message may be a continue message for a receive inactivity period, and the UE 1220 may continue transmitting CLI measurements, as shown by reference number 1255. The UE 120 may continue transmitting CLI measurements if the CLI is greater than the signal strength threshold. The UE 1220 may continue transmitting CLI measurements if the power level of the UE 1220 satisfies the power level threshold (e.g., has enough battery power). The UE 1220 may transmit the CLI measurements to another entity (e.g., network entity 1260) during the receive inactivity period. If the network entity 1210 is not in a receive inactivity period, the UE 1220 may transmit CLI measurements to the network entity 1210. Aspects described herein for transmit inactivity periods may apply to receive inactivity periods. Aspects described herein for receive inactivity periods may apply to transmit inactivity periods.

In some aspects, the UE 1220 may receive, before continuing transmitting of the CLI measurements, a request to pause transmitting of physical uplink channel (e.g., physical uplink control channel (PUCCH), PUSCH) communications and SRSs during the receive inactivity period and ignore the request. The UE 1220 may ignore the request based at least in part on the power level of the UE satisfying the power level threshold.

In some aspects, the network entity 1210 may generate the message based at least in part on traffic priorities, traffic conditions, and/or channel conditions. The network entity 1210 may generate the message based at least in part on information about a power level, energy consumption, or energy harvesting of the UE 1220.

In some aspects, the message may be an RRC message. In one example, the message may include an RRC configuration (e.g., first configuration) that specifies the UE behavior with regards to CLI measurement activity. If DCI is used for dynamic triggering of the transmit inactivity period and/or the receive inactivity period, DCI may not contain any additional information about the CLI measurement activity. This type of message may be used for semi-static patterns where no DCI might be used.

Alternatively, an RRC configuration (e.g., second configuration) for the UE 1220 may not specify the UE behavior associated with CLI measurement activity or specify a dynamic DTX pattern of the network entity 1210. The message may thus be included in DCI used for dynamic triggering of the transmit inactivity period or receive inactivity period. If triggering DCI is used, the UE may use either the first configuration or the second configuration. That is, the DCI may include information about UE behavior associated with CLI measurement activity. The message may be one or more bits in the BS transmit active trigger or BS transmit inactive trigger shown in FIG. 7.

In some aspects, the network entity 1210 may transmit information about the message to a neighboring network entity (e.g., network entity 1260), as shown by reference number 1265. The network entity 1260 may control a UE that transmits CLI SRSs to the UE 1220. The information may indicate the pause or continuation of CLI measurement activity as relayed to the UE 1220. The information may also indicate the transmit inactivity period and/or the receive inactivity period for which the message applies. As shown by reference number 1270, the network entity 1260 may adjust communications based at least in part on the information. This may include adjusting a transmit power or adjusting time and/or frequency resources during the inactivity period of the network entity 1210. Adjustments may also include instructing (e.g., via an RRC message, DCI, or a MAC CE) the UE transmitting CLI SRSs measured by the UE 1220 to pause or continue transmitting the CLI SRSs during the inactivity period of the network entity 1210.

In some aspects, the network entity 1210 may trigger a resource status request to the network entity 1260. The network entity 1260 may transmit a resource request. The network entity 1210 may transmit a response associated with CLI SRS transmission and measurement.

As indicated above, FIG. 12 is provided as an example. Other examples may differ from what is described with regard to FIG. 12.

FIG. 13 is a diagram illustrating an example process 1300 performed, for example, by a UE, in accordance with the present disclosure. Example process 1300 is an example where the UE (e.g., UE 120, UE 1220) performs operations associated with CLI measurement activity during a network inactivity period.

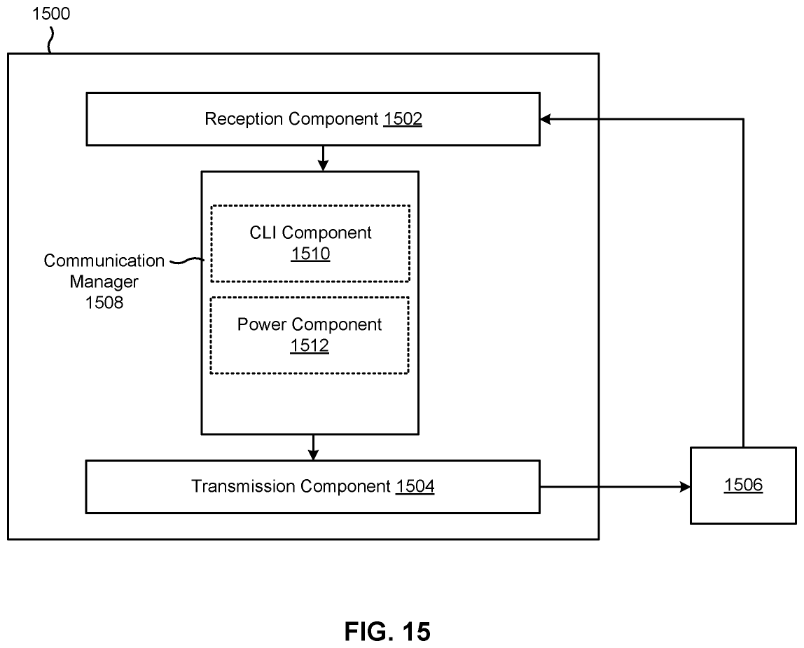

As shown in FIG. 13, in some aspects, process 1300 may include receiving a message associated with CLI measurements during an inactivity period of a network entity (block 1310). For example, the UE (e.g., using communication manager 1508 and/or reception component 1502 depicted in FIG. 15) may receive a message associated with CLI measurements during an inactivity period of a network entity, as described above.

As further shown in FIG. 13, in some aspects, process 1300 may include pausing or continuing CLI measurement activity during the inactivity period based at least in part on the message (block 1320). For example, the UE (e.g., using communication manager 1508 and/or CLI component 1510 depicted in FIG. 15) may pause or continue CLI measurement activity during the inactivity period based at least in part on the message, as described above.

Process 1300 may include additional aspects, such as any single aspect or any combination of aspects described below and/or in connection with one or more other processes described elsewhere herein.

In a first aspect, the inactivity period of the network entity is a transmit inactivity period, where the message is a pause message, and continuing or pausing the CLI measurement activity includes pausing measuring of CLI.

In a second aspect, alone or in combination with the first aspect, pausing measuring of CLI includes pausing measuring of CLI based at least in part on one or more CLI measurements not satisfying a signal strength threshold.

In a third aspect, alone or in combination with one or more of the first and second aspects, pausing measuring of CLI includes pausing measuring of CLI based at least in part on a power level of the UE not satisfying a power level threshold.

In a fourth aspect, alone or in combination with one or more of the first through third aspects, process 1300 includes entering a sleep state based at least in part on pausing the measuring of CLI.

In a fifth aspect, alone or in combination with one or more of the first through fourth aspects, the inactivity period of the network entity is a receive inactivity period, where the message is a pause message and continuing or pausing the CLI measurement activity includes pausing transmitting of CLI measurements.

In a sixth aspect, alone or in combination with one or more of the first through fifth aspects, pausing transmitting of the CLI measurements includes pausing transmitting of the CLI measurements based at least in part on one or more CLI measurements not satisfying a signal strength threshold.

In a seventh aspect, alone or in combination with one or more of the first through sixth aspects, pausing transmitting of the CLI measurements includes pausing transmitting of the CLI measurements based at least in part on a power level of the UE not satisfying a power level threshold.

In an eighth aspect, alone or in combination with one or more of the first through seventh aspects, process 1300 includes transmitting the CLI measurements to the network entity after an end of the receive inactivity period.

In a ninth aspect, alone or in combination with one or more of the first through eighth aspects, the inactivity period of the network entity is a transmit inactivity period, where the message is a continue message and continuing or pausing the CLI measurement activity includes continuing measuring of CLI.

In a tenth aspect, alone or in combination with one or more of the first through ninth aspects, continuing measuring of CLI includes continuing measuring of CLI based at least in part on one or more CLI measurements satisfying a signal strength threshold.

In an eleventh aspect, alone or in combination with one or more of the first through tenth aspects, continuing measuring of CLI includes continuing measuring of CLI based at least in part on a power level of the UE satisfying a power level threshold.

In a twelfth aspect, alone or in combination with one or more of the first through eleventh aspects, process 1300 includes receiving, before continuing measuring of CLI, a request to pause measuring of CSI-RS s during the transmit inactivity period, where the request to pause is ignored based at least in part on a power level of the UE satisfying a power level threshold.

In a thirteenth aspect, alone or in combination with one or more of the first through twelfth aspects, the inactivity period of the network entity is a receive inactivity period, where the message is a continue message, and continuing or pausing the CLI measurement activity includes continuing transmitting of CLI measurements.

In a fourteenth aspect, alone or in combination with one or more of the first through thirteenth aspects, continuing transmitting of the CLI measurements includes continuing transmitting of the CLI measurements based at least in part on one or more CLI measurements satisfying a signal strength threshold.

In a fifteenth aspect, alone or in combination with one or more of the first through fourteenth aspects, continuing transmitting of the CLI measurements includes continuing transmitting of the CLI measurements based at least in part on a power level of the UE satisfying a power level threshold.

In a sixteenth aspect, alone or in combination with one or more of the first through fifteenth aspects, transmitting the CLI measurements includes transmitting the CLI measurements to another network entity during the receive inactivity period.

In a seventeenth aspect, alone or in combination with one or more of the first through sixteenth aspects, process 1300 includes receiving, before continuing transmitting of the CLI measurements, a request to pause transmitting of physical uplink channel communications and SRSs during the receive inactivity period, where the request to pause is ignored based at least in part on a power level of the UE satisfying a power level threshold.

In an eighteenth aspect, alone or in combination with one or more of the first through seventeenth aspects, the message is an RRC message.

In a nineteenth aspect, alone or in combination with one or more of the first through eighteenth aspects, an activity pattern of the network entity is static.

In a twentieth aspect, alone or in combination with one or more of the first through nineteenth aspects, the message is DCI triggering a transmit inactivity state or a receive inactivity state.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a network entity, in accordance with the present disclosure. Example process 1400 is an example where the network entity (e.g., base station 110, network entity 1210) performs operations associated with indicating CLI measurement activity for a network inactivity period.

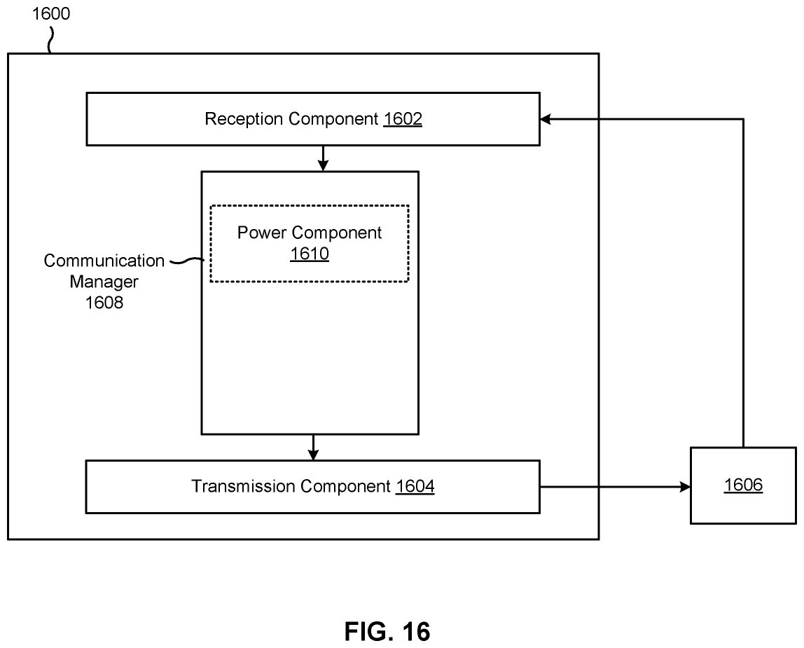

As shown in FIG. 14, in some aspects, process 1400 may include transmitting a message associated with CLI measurements during an inactivity period of a network entity (block 1410). For example, the network entity (e.g., using communication manager 1608 and/or transmission component 1604 depicted in FIG. 16) may transmit a message associated with CLI measurements during an inactivity period of a network entity, as described above.

As further shown in FIG. 14, in some aspects, process 1400 may include entering the inactivity period (block 1420). For example, the network entity (e.g., using communication manager 1608 and/or power component 1610 depicted in FIG. 16) may enter the inactivity period, as described above.

Process 1400 may include additional aspects, such as any single aspect or any combination of aspects described below and/or in connection with one or more other processes described elsewhere herein.

In a first aspect, the inactivity period of the network entity is a transmit inactivity period, and the message is a pause message to pause measuring of CLI during the transmit inactivity period.

In a second aspect, alone or in combination with the first aspect, the inactivity period of the network entity is a receive inactivity period, and the message is a pause message to pause transmitting of CLI measurements.

In a third aspect, alone or in combination with one or more of the first and second aspects, process 1400 includes receiving the CLI measurements after an end of the receive inactivity period.

In a fourth aspect, alone or in combination with one or more of the first through third aspects, the inactivity period of the network entity is a transmit inactivity period, and the message is a continue message to continue measuring of CLI.

In a fifth aspect, alone or in combination with one or more of the first through fourth aspects, process 1400 includes transmitting a request to pause measuring of CSI-RSs during the transmit inactivity period.

In a sixth aspect, alone or in combination with one or more of the first through fifth aspects, the inactivity period of the network entity is a receive inactivity period, and the message is a continue message to continue transmitting of CLI measurements.

In a seventh aspect, alone or in combination with one or more of the first through sixth aspects, process 1400 includes transmitting a request to pause transmitting of physical uplink channel communications and SRSs during the receive inactivity period.

In an eighth aspect, alone or in combination with one or more of the first through seventh aspects, process 1400 includes transmitting information about the message to a neighboring network entity or to other UEs.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication, in accordance with the present disclosure. The apparatus 1500 may be a UE (e.g., UE 120, UE 1220), or a UE may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 1508. The communication manager 1508 may control and/or otherwise manage one or more operations of the reception component 1502 and/or the transmission component 1504. In some aspects, the communication manager 1508 may include one or more antennas, a modem, a controller/processor, a memory, or a combination thereof, of the UE described in connection with FIG. 2. The communication manager 1508 may be, or be similar to, the communication manager 140 depicted in FIGS. 1 and 2. For example, in some aspects, the communication manager 1508 may be configured to perform one or more of the functions described as being performed by the communication manager 140. In some aspects, the communication manager 1508 may include the reception component 1502 and/or the transmission component 1504. The communication manager 1508 may include a CLI component 1510 and/or a power component 1512, among other examples.

In some aspects, the apparatus 1500 may be configured to perform one or more operations described herein in connection with FIGS. 1-12. Additionally, or alternatively, the apparatus 1500 may be configured to perform one or more processes described herein, such as process 1300 of FIG. 13. In some aspects, the apparatus 1500 and/or one or more components shown in FIG. 15 may include one or more components of the UE described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the UE described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the UE described in connection with FIG. 2. In some aspects, the transmission component 1504 may be co-located with the reception component 1502 in a transceiver.

The reception component 1502 may receive a message associated with CLI measurements during an inactivity period of a network entity. The CLI component 1510 may pause or continue CLI measurement activity during the inactivity period based at least in part on the message. The power component 1512 may enter a sleep state based at least in part on pausing the measuring of CLI. The transmission component 1504 may transmit the CLI measurements to the network entity after an end of the receive inactivity period.

The reception component 1502 may receive, before continuing measuring of CLI, a request to pause measuring of CSI-RS s during the transmit inactivity period, where the request to pause is ignored based at least in part on a power level of the UE satisfying a power level threshold.

The reception component 1502 may receive, before continuing transmitting of the CLI measurements, a request to pause transmitting of physical uplink channel communications and SRSs during the receive inactivity period, where the request to pause is ignored based at least in part on a power level of the UE satisfying a power level threshold.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram of an example apparatus 1600 for wireless communication, in accordance with the present disclosure. The apparatus 1600 may be a network entity (e.g., base station 110, network entity 1210), or a network entity may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, or another wireless communication device) using the reception component 1602 and the transmission component 1604. As further shown, the apparatus 1600 may include the communication manager 1608. The communication manager 1608 may control and/or otherwise manage one or more operations of the reception component 1602 and/or the transmission component 1604. In some aspects, the communication manager 1608 may include one or more antennas, a modem, a controller/processor, a memory, or a combination thereof, of the network entity described in connection with FIG. 2. The communication manager 1608 may be, or be similar to, the communication manager 150 depicted in FIGS. 1 and 2. For example, in some aspects, the communication manager 1608 may be configured to perform one or more of the functions described as being performed by the communication manager 150. In some aspects, the communication manager 1608 may include the reception component 1602 and/or the transmission component 1604. The communication manager 1608 may include a power component 1610, among other examples.

In some aspects, the apparatus 1600 may be configured to perform one or more operations described herein in connection with FIGS. 1-12. Additionally, or alternatively, the apparatus 1600 may be configured to perform one or more processes described herein, such as process 1400 of FIG. 14. In some aspects, the apparatus 1600 and/or one or more components shown in FIG. 16 may include one or more components of the network entity described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the network entity described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the network entity described in connection with FIG. 2. In some aspects, the transmission component 1604 may be co-located with the reception component 1602 in a transceiver.

The transmission component 1604 may transmit a message associated with CLI measurements during an inactivity period of a network entity. The power component 1610 may enter the inactivity period.

The reception component 1602 may receive the CLI measurements after an end of the receive inactivity period. The transmission component 1604 may transmit a request to pause measuring of CSI-RS s during the transmit inactivity period.

The transmission component 1604 may transmit a request to pause transmitting of physical uplink channel communications and SRSs during the receive inactivity period. The transmission component 1604 may transmit information about the message to a neighboring network entity or to other UEs.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:

Aspect 1: A method of wireless communication performed by a user equipment (UE), comprising: receiving a message associated with cross-link interference (CLI) measurements during an inactivity period of a network entity; and pausing or continuing CLI measurement activity during the inactivity period based at least in part on the message.

Aspect 2: The method of Aspect 1, wherein the inactivity period of the network entity is a transmit inactivity period, wherein the message is a pause message, and wherein continuing or pausing the CLI measurement activity includes pausing measuring of CLI.

Aspect 3: The method of Aspect 2, wherein pausing measuring of CLI includes pausing measuring of CLI based at least in part on one or more CLI measurements not satisfying a signal strength threshold.

Aspect 4: The method of Aspect 2 or 3, wherein pausing measuring of CLI includes pausing measuring of CLI based at least in part on a power level of the UE not satisfying a power level threshold.

Aspect 5: The method of Aspect 4, further comprising entering a sleep state based at least in part on pausing the measuring of CLI.

Aspect 6: The method of Aspect 1, wherein the inactivity period of the network entity is a receive inactivity period, wherein the message is a pause message, and wherein continuing or pausing the CLI measurement activity includes pausing transmitting of CLI measurements.

Aspect 7: The method of Aspect 6, wherein pausing transmitting of the CLI measurements includes pausing transmitting of the CLI measurements based at least in part on one or more CLI measurements not satisfying a signal strength threshold.

Aspect 8: The method of Aspect 6 or 7, wherein pausing transmitting of the CLI measurements includes pausing transmitting of the CLI measurements based at least in part on a power level of the UE not satisfying a power level threshold.

Aspect 9: The method of any of Aspects 6-8, further comprising transmitting the CLI measurements to the network entity after an end of the receive inactivity period.

Aspect 10: The method of Aspect 1, wherein the inactivity period of the network entity is a transmit inactivity period, wherein the message is a continue message, and wherein continuing or pausing the CLI measurement activity includes continuing measuring of CLI.

Aspect 11: The method of Aspect 10, wherein continuing measuring of CLI includes continuing measuring of CLI based at least in part on one or more CLI measurements satisfying a signal strength threshold.

Aspect 12: The method of Aspect 10 or 11, wherein continuing measuring of CLI includes continuing measuring of CLI based at least in part on a power level of the UE satisfying a power level threshold.

Aspect 13: The method of any of Aspects 10-12, further comprising receiving, before continuing measuring of CLI, a request to pause measuring of channel state information reference signals during the transmit inactivity period, wherein the request to pause is ignored based at least in part on a power level of the UE satisfying a power level threshold.

Aspect 14: The method of Aspect 1, wherein the inactivity period of the network entity is a receive inactivity period, wherein the message is a continue message, and wherein continuing or pausing the CLI measurement activity includes continuing transmitting of CLI measurements.

Aspect 15: The method of Aspect 14, wherein continuing transmitting of the CLI measurements includes continuing transmitting of the CLI measurements based at least in part on one or more CLI measurements satisfying a signal strength threshold.

Aspect 16: The method of Aspect 14 or 15, wherein continuing transmitting of the CLI measurements includes continuing transmitting of the CLI measurements based at least in part on a power level of the UE satisfying a power level threshold.

Aspect 17: The method of any of Aspects 14-16, wherein transmitting the CLI measurements includes transmitting the CLI measurements to another network entity during the receive inactivity period.

Aspect 18: The method of any of Aspects 14-17, further comprising receiving, before continuing transmitting of the CLI measurements, a request to pause transmitting of physical uplink channel communications and sounding reference signals during the receive inactivity period, wherein the request to pause is ignored based at least in part on a power level of the UE satisfying a power level threshold.

Aspect 19: The method of any of Aspects 1-18, wherein the message is a radio resource control message.

Aspect 20: The method of Aspect 19, wherein an activity pattern of the network entity is static.

Aspect 21: The method of any of Aspects 1-20, wherein the message is downlink control information triggering a transmit inactivity state or a receive inactivity state.

Aspect 22: A method of wireless communication performed by a network entity, comprising: transmitting a message associated with cross-link interference (CLI) measurements during an inactivity period of a network entity; and entering the inactivity period.

Aspect 23: The method of Aspect 22, wherein the inactivity period of the network entity is a transmit inactivity period, and wherein the message is a pause message to pause measuring of CLI during the transmit inactivity period.

Aspect 24: The method of Aspect 22, wherein the inactivity period of the network entity is a receive inactivity period, and wherein the message is a pause message to pause transmitting of CLI measurements.

Aspect 25: The method of Aspect 24, further comprising receiving the CLI measurements after an end of the receive inactivity period.

Aspect 26: The method of Aspect 22, wherein the inactivity period of the network entity is a transmit inactivity period, and wherein the message is a continue message to continue measuring of CLI.

Aspect 27: The method of Aspect 26, further comprising transmitting a request to pause measuring of channel state information reference signals during the transmit inactivity period.

Aspect 28: The method of Aspect 22, wherein the inactivity period of the network entity is a receive inactivity period, and wherein the message is a continue message to continue transmitting of CLI measurements.

Aspect 29: The method of Aspect 28, further comprising transmitting a request to pause transmitting of physical uplink channel communications and sounding reference signals during the receive inactivity period.

Aspect 30: The method of any of Aspects 22-29, further comprising transmitting information about the message to a neighboring network entity or to other UEs.

Aspect 31: An apparatus for wireless communication at a device, comprising a processor; memory coupled with the processor; and instructions stored in the memory and executable by the processor to cause the apparatus to perform the method of one or more of Aspects 1-30.

Aspect 32: A device for wireless communication, comprising a memory and one or more processors coupled to the memory, the one or more processors configured to perform the method of one or more of Aspects 1-30.

Aspect 33: An apparatus for wireless communication, comprising at least one means for performing the method of one or more of Aspects 1-30.

Aspect 34: A non-transitory computer-readable medium storing code for wireless communication, the code comprising instructions executable by a processor to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive a message associated with cross-link interference (CLI) measurements during an inactivity period of a network entity; and
pause or continue CLI measurement activity during the inactivity period based at least in part on the message.

2. The UE of claim 1, wherein the inactivity period of the network entity is a transmit inactivity period, wherein the message is a pause message, and wherein the one or more processors are configured to pause measuring of CLI.

3. The UE of claim 2, wherein the one or more processors, to pause measuring of CLI, are configured to pause measuring of CLI based at least in part on one or more CLI measurements not satisfying a signal strength threshold.

4. The UE of claim 2, wherein the one or more processors, to pause measuring of CLI, are configured to pause measuring of CLI based at least in part on a power level of the UE not satisfying a power level threshold.

5. The UE of claim 4, wherein the one or more processors are configured to enter a sleep state based at least in part on pausing the measuring of CLI.

6. The UE of claim 1, wherein the inactivity period of the network entity is a receive inactivity period, wherein the message is a pause message, and wherein the one or more processors are configured to pause transmitting of CLI measurements.

7. The UE of claim 6, wherein the one or more processors, to pause transmitting of the CLI measurements, are configured to pause transmitting of the CLI measurements based at least in part on one or more CLI measurements not satisfying a signal strength threshold.

8. The UE of claim 6, wherein the one or more processors, to pause transmitting of the CLI measurements, are configured to pause transmitting of the CLI measurements based at least in part on a power level of the UE not satisfying a power level threshold.

9. The UE of claim 6, wherein the one or more processors are configured to transmit the CLI measurements to the network entity after an end of the receive inactivity period.

10. The UE of claim 1, wherein the inactivity period of the network entity is a transmit inactivity period, wherein the message is a continue message, and wherein the one or more processors are configured to continue measuring of CLI.

11. The UE of claim 10, wherein the one or more processors, to continue measuring of CLI, are configured to continue measuring of CLI based at least in part on one or more CLI measurements satisfying a signal strength threshold.

12. The UE of claim 10, wherein the one or more processors, to continue measuring of CLI, are configured to continue measuring of CLI based at least in part on a power level of the UE satisfying a power level threshold.

13. The UE of claim 10, wherein the one or more processors are configured to receive, before continuing measuring of CLI, a request to pause measuring of channel state information reference signals during the transmit inactivity period, and wherein the request to pause is ignored based at least in part on a power level of the UE satisfying a power level threshold.

14. The UE of claim 1, wherein the inactivity period of the network entity is a receive inactivity period, wherein the message is a continue message, and wherein the one or more processors are configured to continue transmitting of CLI measurements.

15. The UE of claim 14, wherein the one or more processors, to continue transmitting of the CLI measurements, are configured to continue transmitting of the CLI measurements based at least in part on one or more CLI measurements satisfying a signal strength threshold.

16. The UE of claim 14, wherein the one or more processors, to continue transmitting of the CLI measurements, are configured to continue transmitting of the CLI measurements based at least in part on a power level of the UE satisfying a power level threshold.

17. The UE of claim 14, wherein the one or more processors, to transmit the CLI measurements, are configured to transmit the CLI measurements to another network entity during the receive inactivity period.

18. The UE of claim 14, wherein the one or more processors are configured to receive, before continuing transmitting of the CLI measurements, a request to pause transmitting of physical uplink channel communications and sounding reference signals during the receive inactivity period, and wherein the request to pause is ignored based at least in part on a power level of the UE satisfying a power level threshold.

19. The UE of claim 1, wherein the message is a radio resource control message or downlink control information triggering a transmit inactivity state or a receive inactivity state.

20. A network entity for wireless communication, comprising:
a memory; and
one or more processors, coupled to the memory, configured to:
transmit a message associated with cross-link interference (CLI) measurements during an inactivity period of a network entity; and
enter the inactivity period.

21. The network entity of claim 20, wherein the inactivity period of the network entity is a transmit inactivity period, and wherein the message is a pause message to pause measuring of CLI during the transmit inactivity period.

22. The network entity of claim 20, wherein the inactivity period of the network entity is a receive inactivity period, and wherein the message is a pause message to pause transmitting of CLI measurements.

23. The network entity of claim 22, wherein the one or more processors are configured to receive the CLI measurements after an end of the receive inactivity period.

24. The network entity of claim 20, wherein the inactivity period of the network entity is a transmit inactivity period, and wherein the message is a continue message to continue measuring of CLI.

25. The network entity of claim 24, wherein the one or more processors are configured to transmit a request to pause measuring of channel state information reference signals during the transmit inactivity period.

26. The network entity of claim 20, wherein the inactivity period of the network entity is a receive inactivity period, and wherein the message is a continue message to continue transmitting of CLI measurements.

27. The network entity of claim 26, wherein the one or more processors are configured to transmit a request to pause transmitting of physical uplink channel communications and sounding reference signals during the receive inactivity period.

28. The network entity of claim 20, wherein the one or more processors are configured to transmit information about the message to a neighboring network entity or to other UEs.

29. A method of wireless communication performed by a user equipment (UE), comprising:
receiving a message associated with cross-link interference (CLI) measurements during an inactivity period of a network entity; and
pausing or continuing CLI measurement activity during the inactivity period based at least in part on the message.

30. A method of wireless communication performed by a network entity, comprising:
transmitting a message associated with cross-link interference (CLI) measurements during an inactivity period of a network entity; and
entering the inactivity period.
